(19) United States
(12) Patent Application Publication
(10) Pub. No.: US 2006/0033222 A1
(43) Pub. Date: Feb. 16, 2006

(54) Devices for introducing a gas into a liquid and methods of using the same

(76) Inventors: Scott Aaron Godfrey, Pleasanton, CA (US); Paul Harold Long IV, La Honda, CA (US)

Correspondence Address: DLA PIPER RUDNICK GRAY CARY US LLP;Patent Group, 1200 Nineteenth Street, N.W., Washington, DC, 20036-2412, US

(21) Appl. No.: 11/200,076

(22) Filed: Aug. 10, 2005

Related U.S. Application Data
(60) Provisional application No. 60/601,103, filed on Aug. 11, 2004.

(51) Int. Cl. B01F 3/04

(52) U.S. Cl. 261/122.1; 261/124

(57) ABSTRACT

Devices and methods for introducing a gas into a liquid are provided. Embodiments of the subject devices include spargers that have an inner member having a gas inlet opening and a gas outlet opening and an outer member that has at least one sparge hole. Embodiments of the subject methods include operatively positioning a sparger having an inner member and an outer member having at least one sparge hole inside a liquid held within a vessel and directing gas into the second member from the first member to cause the gas to exit the at least one sparger hole of the second member. Novel systems and kits are also provided.

### CROSS REFERENCES

This application claims the benefit of U.S. Provisional Application Ser. No. 60/601,103, filed Aug. 11, 2004. The contents of which is hereby incorporated herein by reference.

### BACKGROUND OF THE INVENTION

The introduction of a gas to a liquid is necessary in a wide variety of applications from waste water treatment to food processing to the processing of living materials such as cells, plants and microorganisms. For example, in cell culture systems it is a requirement that the cells be aerated.

Aeration of biological material, such as the aeration of living cells in a cell culture system, may be accomplished with a sparger. A sparger is a device that introduces a gas such as oxygen or a mixture of gases into a liquid, usually by the dispersion of bubbles into the cell culture medium.

A variety of spargers are known and used. For example, in biotechnology applications, such as cell culturing applications, porous materials made of glass or metal may be used as spargers, as well as straight tube spargers that have a single hole at one end, ring tube spargers that include a hollow tube having a plurality of small holes, rubber tubing manifold spargers with needle tips, and porous Teflon bags.

Due to their particular configurations, none of these conventional spargers can be cleaned or sterilized in a manner to meet federally promulgated standards for cleaning and sterilizing spargers while the sparger is operatively associated with a vessel holding the liquid in need of sparging. Rather, in order to clean and sterilize these spargers according to governmental standards such as the Food and Drug Administration standards, each sparger must first be disassociated and removed from its respective vessel and then cleaned by hand and/or sterilized. Many spargers are not even amendable to cleaning and sterilizing once removed and must simply be discarded after use. Removing a sparger from a vessel to clean and sterilize the sparger, and then again operatively associating the sparger with a vessel, is labor and time intensive and increases handling of the sparger which, in turn, increases the risk of damage to the sparger and contamination of the vessel contents.

As spargers continue to be used in many applications, especially in the growing area of cell culture, there continues to be an interest in the development of spargers and methods of using spargers to introduce a gas into a liquid such as a cell culture medium. Of interest are spargers that do not adversely affect the cell culture medium with which they are used, may be cleaned-in-place, may be sterilized-in-place, and which may be employed in a wide variety of applications.

### SUMMARY OF THE INVENTION

Devices and methods for introducing a gas into a liquid are provided. Embodiments of the subject devices include spargers that have an inner member having a gas inlet opening and a gas outlet opening and an outer member that has at least one sparge hole. Embodiments of the subject devices are configured to be cleaned-in-place in a vessel and sterilized-in-place in a vessel, e.g., in accordance with US Food & Drug Administration (“FDA”) standards.

Methods of introducing a gas into a liquid are also provided. Embodiments of the subject methods include operatively positioning a sparger, having a first or an inner member and a second or an outer member having at least one sparge hole, inside a liquid held within a vessel and directing gas into the second member from the first member to cause the gas to exit the at least one sparger hole of the second member. In certain embodiments, the subject methods may be employed with cell culture protocols, e.g., to introduce oxygen or oxygen-containing gas to a cell culture medium or to remove carbon dioxide from a cell culture medium.

Novel systems and kits are also described. Embodiments of the subject systems may include a vessel and a sparger that includes an inner member having a gas inlet opening and a gas outlet opening and an outer member that has at least one sparge hole and a vessel. In certain embodiments, the vessel may be a cell or microorganism culture bioreactor. Embodiments of the subject kits may include a subject sparger for introducing a gas into a liquid and a vessel for use with the sparger. Kit embodiments may include instructions for coupling a sparger to a vessel and/or for using the sparger while coupled to a vessel, e.g., instructions for cleaning or sterilizing the sparger while coupled to a vessel.

### BRIEF DESCRIPTIONS OF THE DRAWINGS

FIG. 1 shows an exemplary embodiment of a sparger device according to the subject invention.

FIG. 2 shows a view through the sparger of FIG. 1.

FIG. 3 shows the inner member of FIG. 2.

FIG. 4 shows the outer member of FIG. 2.

FIG. 5 shows a cross-sectional view of the outer member of FIG. 2.

FIG. 6 shows exemplary geometries of outer member distal ends.

FIG. 7 shows an exemplary embodiment of a vessel that may be employed in the practice of the subject invention.

FIG. 8 shows an exemplary embodiment of a system according to the subject invention that includes an exemplary sparger and vessel.

FIG. 9 shows the flow of cleaning solution and/or rinse liquid through a subject sparger.

FIG. 10 shows the flow of clean steam and clean steam condensate through a subject sparger.

FIGS. 11A and B show the mass transfer of oxygen into a cell culture medium in a 500 liter bioreactor system using an exemplary embodiment of the present invention. FIG. 11A is a graphical representation of an oxygen mass transfer experiment showing an increase in percent dissolved oxygen in culture medium over time using a sparger of the present invention. FIG. 11B is a graph of the natural log of [(100−DO %)] over time from which the mass transfer rate may be determined from the slope of the line.

FIGS. 12A and B show in-place steam sterilization an exemplary sparger of the present invention in a 500 liter bioreactor system. FIG. 12A is a graphical representation of the sparger tip temperature measured during steam sterilization over a period of about 100 minutes. FIG. 12B is a graph of the number of equivalent minutes of steam sterilization at temperature 121.1° C. delivered to the bioreactor (Fo Time) over a period of about 1 hour.

### DETAILED DESCRIPTION OF THE INVENTION

Devices and methods for introducing a gas into a liquid are provided. Embodiments of the subject devices include spargers that have an inner member having a gas inlet opening and a gas outlet opening and an outer member that has at least one sparge hole. Embodiments of the subject devices are configured to be cleaned-in-place in a vessel and sterilized-in-place in a vessel, e.g., in accordance with US Food & Drug Administration's standards.

Methods of introducing a gas into a liquid are also provided. Embodiments of the subject methods include operatively positioning a sparger having an inner member and an outer member having at least one sparge hole inside a liquid held within a vessel and directing gas into the second member from the first member to cause the gas to exit the at least one sparger hole of the second member. In certain embodiments, the subject methods may be employed with cell culture protocols, e.g., to introduce oxygen or oxygen-containing gas to a cell culture medium or to remove carbon dioxide from a cell culture medium.

Novel systems and kits are also described. Embodiments of the subject systems may include a vessel and a sparger that includes an inner member having a gas inlet opening and a gas outlet opening and an outer member that has at least one sparge hole and a vessel. In certain embodiments, the vessel may be a cell- or microorganism culture bioreactor. Embodiments of the subject kits may include at least one sparger according to the subject invention.

Before the present invention is described, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described. All publications mentioned herein are incorporated herein by reference to disclose and describe the methods and/or materials in connection with which the publications are cited.

It must be noted that as used herein and in the appended claims, the singular forms “a”, “an”, and “the” include plural referents unless the context clearly dictates otherwise.

When two or more items (for example, elements or processes) are referenced by an alternative “or”, this indicates that either could be present separately or any combination of them could be present together except where the presence of one necessarily excludes the other or others.

It will also be appreciated that throughout the present application, that words such as “top”, “bottom” “front”, “back”, “upper”, and “lower” and analogous terms are used in a relative sense only.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention.

The figures shown herein are not necessarily drawn to scale, with some components and features being exaggerated for clarity.

In further describing the subject invention in greater detail, embodiments of the subject devices are described first, followed by a review of embodiments of systems according to the subject invention that include the novel spargers. Next, a description of embodiments of the subject methods is provided. A discussion of representative applications in which the subject invention may find use is then provided, followed by a description of kits according to the subject invention.

DEVICES

As summarized above, the subject invention includes devices for introducing a gas into a liquid. In general, device embodiments of the subject invention include an opening for receiving gas from a gas source (or a liquid from a liquid source (e.g., cleaning liquid) or steam from a steam source) and one or more sparge holes positioned about at least a portion of a wall of the device for providing gas bubbles to a liquid in contact with the device. Device embodiments include two members: a first member that is substantially disposed inside a second member. Accordingly, embodiments may be characterized by an inner member substantially surrounded by an outer member. The second or outer member includes at least one sparge hole or bore within a wall of the outer member (e.g., circumferential wall in the case of cylindrical spargers) through which gas is transported from a region inside the device to a liquid in contact with the device.

The novel configuration of the subject devices provides a number of important features and advantages, described herein and which will be apparent to one of skill in the art upon reading this disclosure. For example, embodiments of the subject devices are capable of effectively and efficiently introducing gas into a liquid without substantial turbulence of the liquid, which may be a requirement in certain applications in which it is desirable to keep the disturbance of the liquid to a minimum, such as for example in certain cell culture protocols and the like.

As will be described in greater detail below, the subject invention provides device embodiments that are configured to permit the devices to be cleaned-in-place and/or sterilized-in-place, e.g., in a manner that meets FDA cleaning and/or sterilization standards, such that certain embodiments are capable of being cleaned and sterilized on-line (in situ) and need not be disassociated from a vessel with which they are used in order for the spargers to be cleaned and/or sterilized. The subject spargers may be provided with a vessel or otherwise configured to be used with certain types of vessel or may be universal such that they may be constructed for retrofitting vessels currently on the market.

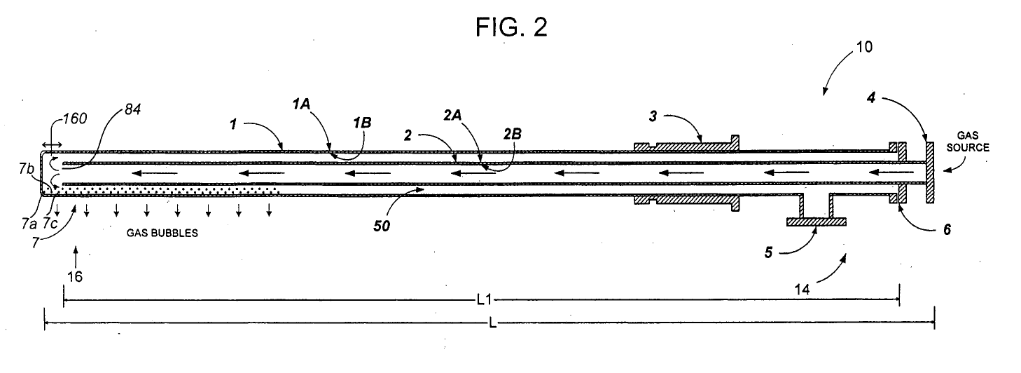

The devices of the subject invention may be any suitable shape. While exemplary embodiments of the subject devices are described primarily herein as having a substantially cylindrical body, it is to be understood that such is for exemplary purposes only and in no way is intended to limit the scope of the invention as the subject devices may assume a wide variety of shapes. Embodiments may be in the form of a tapered or conical outer member and/or a tapered or conical inner member. The inner and outer members may be straight or curved, i.e., the inner and outer members do not necessarily need to be straight, and the inner member and/or outer member may be curved in certain embodiments. The inner member may be positioned within the outer member in any suitable manner. For example, the inner member may be eccentric inside the outer tube, or otherwise not centered within the outer tube. For example, the members may or may not be coaxial. Exemplary cross sections of the inner and outer tubes may be circular, triangular, oval, polygonal, or any amorphous shape, insofar as cleaning, sterilization, and sparger operation functionality is maintained. Additionally, the cross section does not need to be constant throughout the length of the inner member and/or outer member, e.g., one or both members may have a circular cross section at one end and have an oval form at the other end. First and second members need not be of the same shape, however in certain embodiments first and second members will have the same shape, e.g., both may be substantially tubular in shape (see for example FIG. 2), such that the inner and/or outer members may be cylindrical, i.e., have a substantial cylindrical cross-sectional profile. In this manner, in certain embodiments the inner and/or outer member may be characterized as an elongated member with a cross-section that may be circular, square, oval, rectangular, etc.

The subject devices may be constructed from wide variety of materials, where the material(s) are chosen at least for compatibility with the liquids with which they may be contacted. The materials(s) of construction may also be chosen to withstand any conditions to which the devices may be subjected, at least for a period of time, or may be rendered so capable (e.g., may include a suitable surface treatment such as a surface coating, etc.). In certain embodiments, devices may be coated (interiorly and/or exteriorly) with a material to minimize wear to the devices. Embodiments of the subject invention may be constructed of material that is capable of withstanding contact with cell or microorganism culture medium, which capability may be for a period of time at least commensurate with the performance of one or more cell or microorganism culture protocols. In other words, the devices are constructed to withstand a condition to which it is subjected and retain its ability to perform its intended use of introducing gas into a liquid.

Representative materials that may be employed in the construction of the subject devices include, but are not limited to, metals or metal alloys, such as stainless steel (e.g., 316L stainless steel), titanium, copper, gold, silver, nickel, aluminum, HASTELLOY® such as HATELLOY C-22® alloy, copper-nickel alloy such as MONEL®, ferrous metals such as coated ferrous metals; polymeric materials including synthetic and naturally occurring polymers such as plastics and other polymeric materials such as polycarbonates, polyethylenes, high density polyethylene (HDPE), medium density polyethylene (MDPE), styrenes such as acrylonitrile-butadiene-styrene copolymers, cellulosics such as cellulose butyrate, ethyl vinyl acetates, polyetheretherketones (PEEK), polyesters, poly(methyl methacrylate) (PMMA), polypropylenes, polytetrafluoroethylenes (e.g., TEFLON®), and blends thereof; siliceous materials, e.g., glasses, fused silica, ceramics and the like; and a combination of any of two or more materials described above or others.

A portion or the entirety of a given device may be fabricated from a “composite”. “Composite” in this context may refer to devices having a plurality of material layers joined together, where the layers may be of the same or different material. A device composite may be a block composite, e.g., an A-B-A block composite, an A-B-C block composite, or the like. A composite may be a heterogeneous combination of materials, i.e., in which the materials are distinct from separate phases, or a homogeneous combination of unlike materials. As used herein, the term “composite” is used to include a “laminate” composite. A “laminate” refers to a composite material formed from several bonded layers of identical or different materials.

The subject gas transfer devices may be any suitable size. The size of a given device will depend upon a variety of factors, such as, but not limited to one or more of, the volume of liquid with which the device is used, the type of fluid with which the device is used, etc. As noted above, certain embodiments may be configured to be reusable and cleaned and/or sterilized on-line, i.e., without disassociation from a vessel with which it is used, between uses (e.g., between production of cell culture batches), and as such may be dimensioned to provide suitable flow rates for cleaning and sterilization solutions (and/or gases) which may at least meet flow rates set-forth by the FDA for such processes.

In certain embodiments, devices may be dimensioned to have interior volumes that range from about from about 5 ml to about 500 liters, e.g., from about 10 ml to about 50 ml e.g., from about 50 ml to about 100 ml.

In certain embodiments having a tubular geometry, the length of such a device may range from about 5 cm to about 50 meters, e.g., from about 20 cm to about 200 cm, e.g., from about 30 cm to about 65 cm. For example, embodiments may have lengths that range from about 5 cm to about 50 meters when employed in large scale cell culturing processes, e.g., when used to introduce gas to about 700 liters to about 800 liters of fluid (e.g., cell culture medium). The outer diameter of a subject device may range from about 5 mm to about 15 cm, e.g., from about 1 cm to about 5 cm, e.g., from about 1.5 cm to about 2.5 cm. For example, embodiments may have outer diameters that range from about 5 mm to about 15 cm when employed in large scale cell culturing processes, e.g., when used to introduce gas to about 700 liters to about 800 liters of liquid (e.g., cell culture medium).

As noted above, the subject devices, and more specifically the outer member of the subject devices, includes at least one sparge hole and in certain embodiments may include a plurality of sparge holes. The one or more sparge holes of the devices provide one or more communication openings through which gas (or a liquid or steam in certain device cleaning and sterilization processes as will be described in greater detail below) may flow from a region inside of the device to outside of the device so as to be introduced to a liquid in contact with the device. As such, a given sparge hole traverses the entire wall thickness of the outer member of the device, i.e., each sparge hole extends in a wall thickness dimension of the outer member.

The diameter of the one or more sparge holes may be any suitable diameter (or width for non-round holes) and may be constant throughout a given sparge hole or may change, e.g., the diameter may increase or decrease from a sparge hole opening adjacent the inside surface of the outer member wall and the sparge hole opening adjacent the outside surface of the outer member wall. In certain embodiments, the one or more sparge holes may be sized to provide a particular size of gas bubbles to a liquid, e.g., bubbles small enough to minimize turbulence of the surrounding liquid. For example, in cell culture applications in which a device is used with a bioreactor that includes cells in a culture medium, sparge holes may be sized to provide bubbles of a size that do not produce cellular damage due to bubble turbulence. In certain embodiments, it may be desirable to provide bubbles produced by a subject sparger of a size that may facilitate mixing of the contacted liquid and thus the one or more sparge holes may be so sized.

In certain embodiments, the one or more sparge holes may be sized to produce bubbles having a mean diameter that may range from about 100 μm to about 1 meter, e.g., from about 0.5 mm to about 5 cm, e.g., from about 1 mm to about 1 cm. In certain embodiments, the diameter of a sparge hole may range from about 200 μm to about 5 cm, e.g., from about 100 μm to about 1 cm, e.g., from about 400 μm to about 600 μm. In those embodiments having a plurality of sparge holes, the mean diameter of the plurality may fall within these ranges in certain embodiments.

In certain embodiments, a sparge hole may include a screen covering thereover. In this manner, gas may be transferred from the inside of the sparger to outside through the screen of a sparge hole. A screen may have openings of a size suitable to produce bubbles of particular sizes. If a plurality of sparge holes are present, some or all may include screens. The screen may be permanently affixed over a sparge hole or may be readily removable therefrom, thus increasing the versatility of the sparger by enabling bubbles of different sizes to be produced thereby for different applications, simply by changing one or more screens positioned over one or more sparge holes. For example, a sparger may be provided to a user of the device with a plurality of different screens, e.g., each having different sized openings. In this manner, the user may select which screen is suitable for a particular use.

A sparge hole may be any shape, where in certain embodiments a sparge hole may be circular in shape, however the one or more sparge holes are not limited to any particular shape and may be square, rectangle, oval, triangular, polygonal (e.g., octagonal, pentagonal, hexagonal), etc., or a combination thereof. In those embodiments having a plurality of sparge holes, all of the sparge holes may be of the same shape or some or all of the holes may be of different shapes. For example, in certain embodiments, all of the sparge holes may be circular.

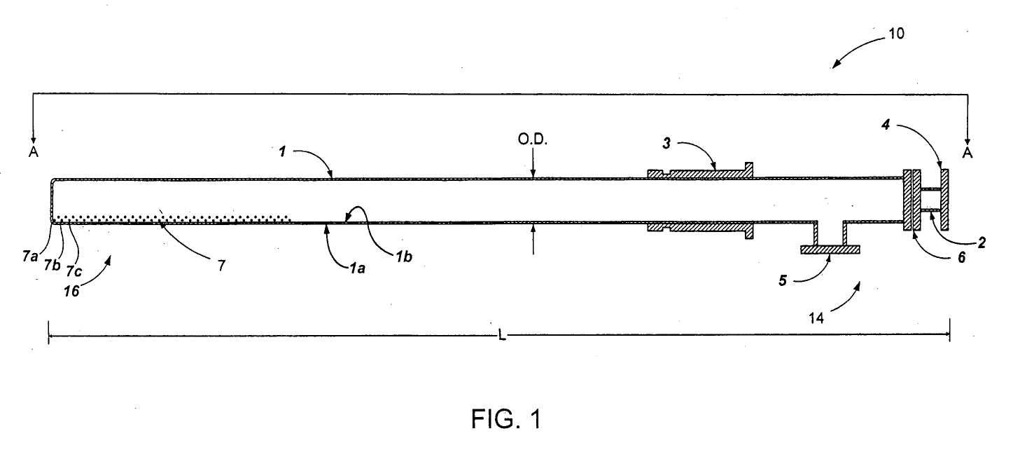

As noted above, certain sparger embodiments may include a plurality of sparge holes (see for example plurality of sparge holes 7 of device 10 of FIGS. 1 and 2 that includes sparge holes 7a, 7b, 7c . . . ). In such embodiments, the number of sparge holes present may vary, where the number present may depend on the particular application with which the device is used. The number of sparge holes may range from about 1 to about 10,000 or more, e.g., 5 to about 1,000, e.g., from about 10 to about 100, e.g., for a device having dimensions that fall within the ranges described herein.

Sparge holes, if more than one, may be spaced apart from one another by inter-sparge hole regions. The distances between adjacent sparge holes of a given device may be constant for all adjacent sparge holes or the distances between various sparge holes of a given device may vary. The distance between two adjacent sparge holes may be characterized by the distance between the center points of the adjacent sparge holes where in certain embodiments this distance may range from about 200 μm to about 50 meters, e.g., from about 1 mm to about 2 meters, e.g., from about 2 mm to about 50 mm. In those embodiments that include a plurality of sparge holes, the plurality of sparge holes may be arranged in any suitable configuration, which configuration may be based at least in part on the particular application in which a given device is designed to be used. For example, sparge holes may be present in a random pattern about at least a portion of the circumferential surface area of the outer member of a device. In certain embodiments, the sparge holes may be present in an organized pattern about at least a portion of the circumferential surface area of the outer member of a device, where the pattern may be in the form of, e.g., organized rows and columns of sparge holes, e.g. a grid of holes (such as an x-y grid and the like), about at least a portion of the circumferential surface area of the outer member of a device, a curvilinear rows across at least a portion of the circumferential surface area of the outer member of a device, and the like.

The one or more sparge holes may be positioned about any suitable location of a device. In certain embodiments, the one or more sparge holes may be positioned at the distal end of a device, though this need not be necessary and in certain embodiments the one or more sparge holes may be positioned elsewhere, e.g., may be positioned along the entire length dimension of a given device. In certain embodiments, at least one sparge hole may be positioned at a distal-most end of a given device, such as a distal tip region of the distal end of a device. This may be desired, for example, in certain steam sterilization applications, e.g., sterilization-in-place protocols, described in greater detail below.

In those embodiments having a plurality of sparge holes, the sparge holes may be positioned about the entire wall of a device, e.g., about the entire wall of the distal end of the a device, or may only be present about a portion of a device, e.g., about a portion of the 360° circumference (for cylindrical devices) of the outer member, e.g., in a range from about 0° to about 360°, e.g., 90° to about 270°, e.g., from about 120° to about 210°. Sparge holes may only cover a portion of a device, e.g., the distal end of a device and even a portion of the distal end of a device in certain embodiments. For example, in certain embodiments the plurality of sparge holes may cover from about 0% to about 100% of a given device, e.g., from about 1% to about 50% of a given device, e.g., from about 10% to about 20% of a given device. The density of sparge holes may range from about 4.5×10⁻⁶ holes/cm² to about 1.1×10³ holes/cm², e.g., from about 5×10⁻³ holes/cm² to about 204 holes/cm², e.g., from about 3.6×10⁻³ holes/cm² to about 5 holes/cm². The density may be constant over the entire sparge hole region or may vary. Embodiments may include devices having a length of about 45 cm, a diameter of about 2 cm, and about 50 sparge holes with a mean diameter of about 0.020 inches. The sparge holes may be positioned about the distal end of such an embodiment in an area that ranges from about 20 cm² to about 280 cm².

In certain embodiments, the perimeter of an opening of one or more sparge holes may be surrounded by a nozzle or the like to assist in directing gas or liquid in a particular direction from the sparge hole.

FIG. 1 shows an exemplary embodiment of a subject gas introduction device 10, configured to provide gas bubbles to a liquid (and/or remove gas from a liquid). In this aspect, device 10 is a sparger. In this particular embodiment, device 10 is shaped generally as a cylinder. Device 10 includes two members: an inner member 2 and an outer member 1. Device 10 has a total length L and an outer diameter OD and includes a proximal end 14 that includes an opening 4 for intaking gas from a gas source (or fluid or steam from respective sources) and a distal end 16 that is closed except for the plurality of sparge holes 7 for bubbling the gas to a liquid in contact with device 10. Proximal end also include at least outlet port 5 which is openable and closeable in response to manual or automatic controls. Outlet 5 may include one or more flow control valves, plugs, caps, etc., to enable outlet 5 to be repeatedly opened and closed, e.g., automatically. As will be described in greater detail below, flow through outlet 5 may be closed during gas sparging so that gas is directed solely through sparge holes 7. Flow through outlet 5 may be opened during certain cleaning and/or sterilization processes.

Inner member 2 and outer member 1 may be held together in an operative arrangement relative to each other, and which operative arrangement may be characterized by the inner member stably disposed inside the outer member, using any suitable manner of connection 6, e.g., friction fit, snap fit, mechanical clamp, permanent or temporary weld, permanent or temporary adhesive, and the like. In certain embodiments, connection 6 may be a sanitary connection, e.g., in applications which require sanitary conditions such as in cell culture, food processing, and the like. For example, a tri-clover sanitary fitting may be employed to maintain inner member 2 and outer member 1 in an operative positioning with respect to each other. The inner member may be permanently maintained within the outer member (i.e., irremovable) or may be slideably removable therefrom.

FIG. 2 shows a view taken along lines A-A of device 10 of FIG. 1. However in the view of FIG. 2, optional vessel positioning fitting 3 is shown about device 10. Fitting 3 is mateable to a corresponding fitting of a vessel with which device 10 is to be used. Fitting 3 may be permanently or temporarily affixed to device 10 and more specifically to outer member 1. Fitting 3 may be affixed using e.g., friction fit, snap fit, mechanical clamp, permanent or temporary weld, permanent or temporary adhesive, and the like. In certain embodiments, fitting 3 may be a male Ingold type fitting or modification thereof that is mateable with a female Ingold type fitting or modification thereof associated with (e.g., welded-in) a vessel wall such as a wall of a cell culture bioreactor or the like. Other fitting technologies may be used as well, e.g., triclamp, I-line, European Standard sanitary fittings, and the like.

As shown in FIG. 2, the inner member is spaced apart from the end of the outer member at the distal end by a space or gap 160. Likewise, the inner member is spaced apart from the outer member along the length of the device by distance 50 such that a space is provided between the inner and outer members. More specifically, inner member 2 may be described as having an outer wall surface 2a and an inner wall surface 2b, and outer member 1 may be described as having an outer wall surface 1a and an inner wall surface 1b. A space or gap 50 is provided between outer wall surface 2a of inner member 2 and inner wall surface 1b of outer member 1. Gaps 50 and 160 are chosen to provide high velocity through device 10 as gas (or liquid or steam, e.g., for cleaning and sterilization) is introduced through gas inlet 4 and caused to travel through the inner member to gas outlet 15 and forced out sparge holes 7 of outer member 1 to the outside environment of the device. Distance 50 may be substantially constant along at least a part, if not all, of the length of L1, or may vary along at least a part, if not all, of the length L1. In certain embodiments, distance 160 may range from about 1 cm to about 100 cm. In certain embodiments, distance 50 may range from about 0.1 cm to about 1 cm.

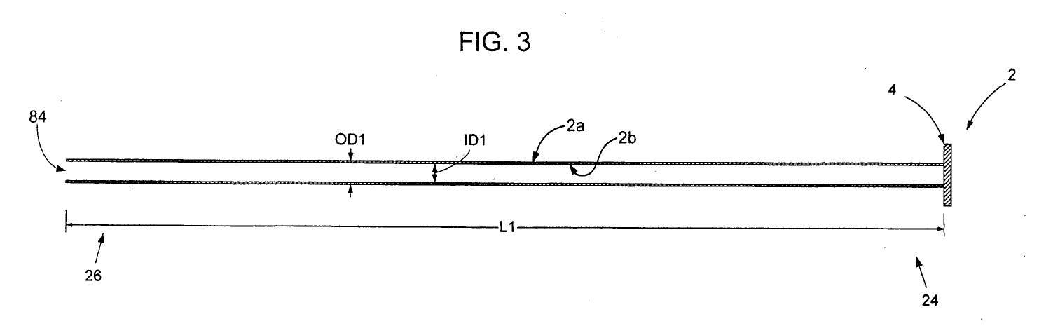

FIG. 3 shows inner member 2 having proximal end 24 that includes gas inlet opening 4 and distal end 26 that includes gas outlet opening 84. The length L1 of inner member 2 may range from about 5 cm to about 50 meters, e.g., from about 20 cm to about 200 cm, e.g., from about 28 cm to about 63 cm. For example, embodiments may have lengths that range from about 30 cm to about 40 cm when employed in large scale cell culturing processes, e.g., when used to introduce gas to about 700 liters to about 800 liters of liquid (e.g., cell culture medium). The outer diameter OD1 of inner member 2 may range from about 1 mm to about 15 cm, e.g., from about 5 mm to about 10 cm, e.g., from about 1 cm to about 2 cm. For example, embodiments may have outer diameters that range from about 10 mm to about 15 mm when employed in large scale cell culturing processes, e.g., when used to introduce gas to about 700 liters to about 800 liters of liquid (e.g., cell culture medium). The inner diameter ID1 of inner member 2 may range from about 1 mm to about 15 cm, e.g., from about 4 mm to about 10 cm, e.g., from about 9 mm to about 20 mm. For example, embodiments may have inner diameters that range from about 9 mm to about 15 mm when employed in large scale cell culturing processes, e.g., when used to introduce gas to about 700 liters to about 800 liters of liquid (e.g., cell culture medium). The inner member may have a substantially constant inner diameter along at least a part, if not all, of its length, or may have an inner diameter that varies along at least a part, if not all, of its length. Inner member 2 may be constructed to have wall thickness that range from about 45 μm to about 7 cm, e.g., from about 0.5 mm to about 1 cm, e.g., from about 1 mm to about 2 mm.

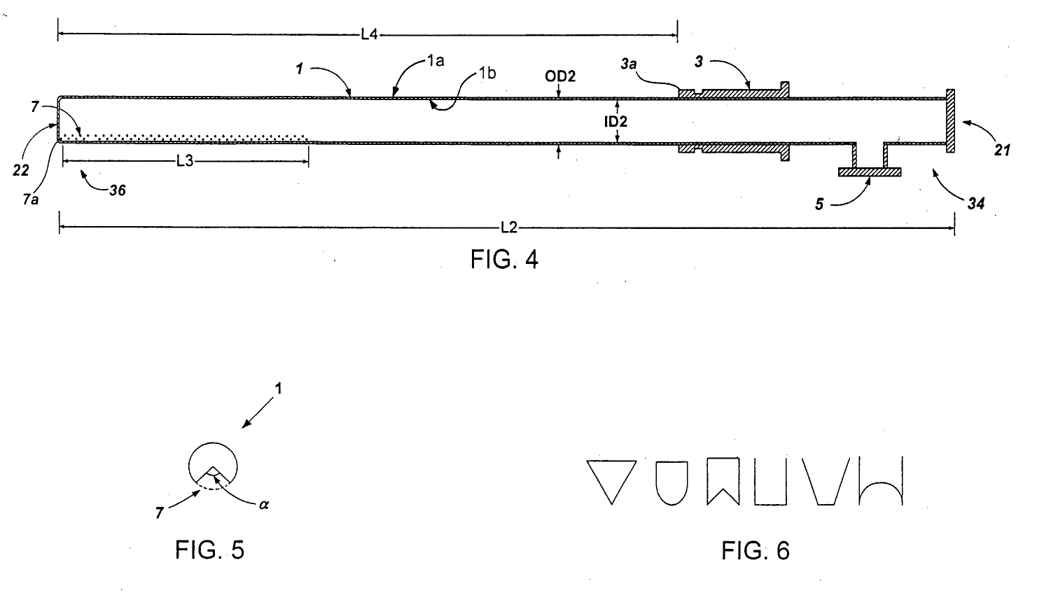

FIG. 4 shows outer member 1 having proximal end 34 that includes opening 21 for receiving inner member 2 and outlet 5 and distal end 36 that is closed except for sparge holes 7. The length L2 of outer member 1 may range from about 5 cm to about 50 meters, e.g., from about 20 cm to about 200 cm, e.g., from about 30 cm to about 65 cm. For example, embodiments may have lengths that range from about 5 cm to about 50 meters when employed in large scale cell culturing processes, e.g., when used to introduce gas to about 700 liters to about 800 liters of liquid (e.g., cell culture medium). The outer diameter OD2 of outer member 1 may range from about 5 mm to about 15 cm, e.g., from about 1 cm to about 5 cm, e.g., from about 1.5 cm to about 2.5 cm. For example, embodiments may have outer diameters that range from about 5 cm to about 15 cm when employed in large scale cell culturing processes, e.g., when used to introduce gas to about 700 liters to about 800 liters of liquid (e.g., cell culture medium). The inner diameter ID2 of outer member 1 may range from about 5 mm to about 15 cm, e.g., from about 1 cm to about 5 cm, e.g., from about 1.5 cm to about 2.5 cm. For example, embodiments may have inner diameters that range from about 5 cm to about 15 cm when employed in large scale cell culturing processes, e.g., when used to introduce gas to about 700 liters to about 800 liters of liquid (e.g., cell culture medium). Outer member 1 may be constructed to have wall thickness that range from about 0.25 mm to about 10 cm, e.g., from about 0.5 mm to about 5 cm, e.g., from about 1 mm to about 2 mm. The outer member may have a substantially constant inner diameter along at least a part, if not all, of its length, or may have an inner diameter that varies along at least a part, if not all, of its length.

FIG. 4 also shows optional fitting 3 for affixing device 10 to a vessel such as a bioreactor (e.g., a cell culture bioreactor or the like) having a corresponding fitting. Fitting 3 may be positioned in any suitable location about device 10, where the particular location may be chosen with respect to variety of factors such as the fitting type, bioreactor configuration, etc. For example, in certain embodiments the distal end 3a of fitting 3 may be positioned a distance L4 from the end of the outer member that ranges from about from about 5 cm to about 50 m, e.g., from about 20 cm to about 200 cm, e.g., from about 40 cm to about 50 cm.

As noted above, sparge holes 7 may be present about the entire outer member or only a portion of the outer member. For example, sparge holes 7 may be present about the entire length L2 of the outer member or only a portion of the length L2 of the outer member. The length L3 of the region that includes the sparge holes may vary, where in certain embodiments length L3 may range from about 200 μm to about 50 m, e.g., from about 1 cm to about 200 cm e.g., from about 10 cm to about 20 cm. In certain embodiments, sparge holes 7 may be positioned about the entire surface of outer member 1, or in certain embodiments may be present about a portion of outer member 1.

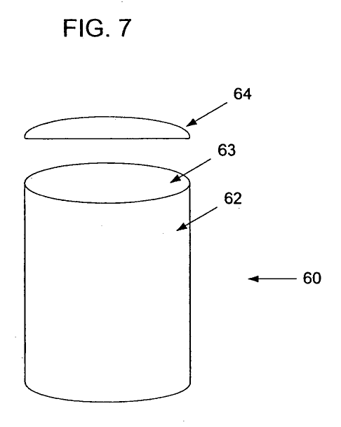

FIG. 5 shows a cross sectional view through outer member 1 showing sparge holes 7. Sparge holes may encompass an angle α that ranges from about 0° to about 360°, e.g., from about 90° to about 270°, e.g., from about 120° to about 210°.

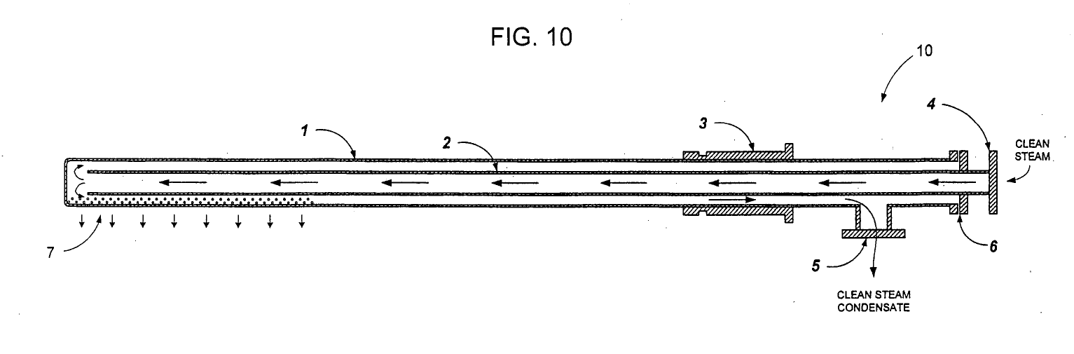

As noted above, in certain embodiments at least one sparge hole 7a (see for example FIGS. 4 and 8) may be positioned near the distal tip of the outer member, e.g., to facilitate sterilization of the device while left in place in a vessel, e.g., to provide an opening from which condensate may drain from the sparger. In such embodiments, the device may be downwardly positioned (i.e., the distal end of the device is closest to the bottom of the vessel than the proximal end of the device) relative to a wall of a vessel at a suitable angle (e.g., at about a 15° angle relative to a wall of the vessel) such that that at least one of the sparge holes is positioned at or near the lowest point (relative to the bottom of the vessel) of the device when so positioned.

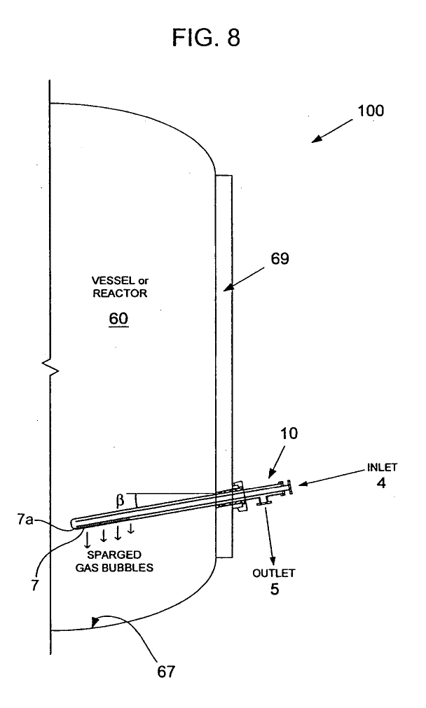

Distal end 36 of outer member 1 includes distal wall portion 22. Wall portion 22 may be any suitable shape. For example, distal wall portion 22 may be convex, concave, squared, rounded, triangular, etc. FIG. 6 shows a portion of outer member 10 having various distal wall portion configurations. The inner surface of the distal wall member may include optional surface features or modifications to facilitate gas and/or fluid flow, such as raised bumps, depressions, grooves, etc.

SYSTEMS

Also provided are systems for introducing a gas to a liquid. Embodiments of the subject systems may include a vessel for containing a liquid, e.g., for processing, and a subject sparger. Embodiments may also include liquids, e.g., liquids used in biological processes such as cell culture mediums and/or cells. Other components may also be included such as various system components for carrying out the particular process of interest, e.g., food processing, cell culturing, water treatment, and the like.

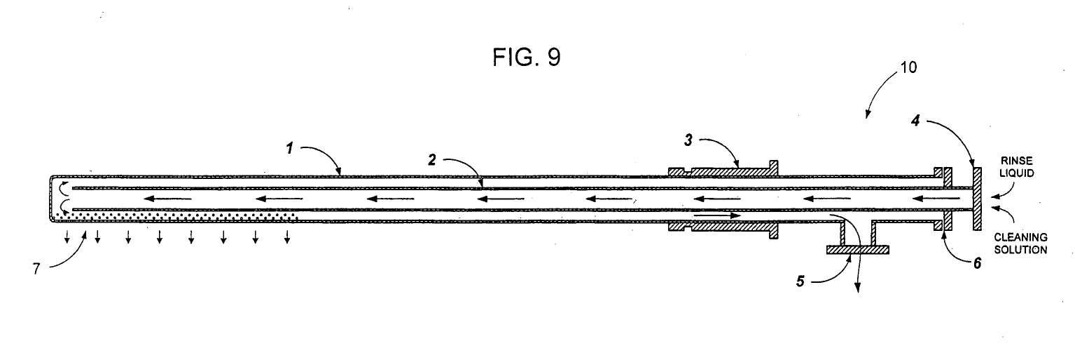

Vessel embodiments may include a housing having an interior chamber. A cover for covering the chamber may also be included. FIG. 7 shows an exemplary embodiment of a bioreactor 60 that includes housing 62 forming interior chamber 63 for retaining a liquid. By “bioreactor” is meant broadly to include a vessel for performing bioprocesses. Bioprocesses are important in a wide variety of industries such as biotechnology, pharmaceutical, food, ecology and water treatment, e.g., applications such as the human genome project. In certain embodiments, a bioreactor may be a cultivation vessel, e.g., configured for enhancing the biomass yield of cells in a nutrient medium. Bioreactors are known in the art and have been widely used for, e.g., the production of biological products from both suspension and anchorage dependent animal cell cultures.

Chamber 63 is shown as a single chamber in FIG. 7, but a plurality of chambers may be provided in certain embodiments. For example, if an application requires a plurality of different sets of conditions, e.g., to determine growth optimization for a particular cell line or the like, then a housing having a plurality of separate sub-chambers may be employed to prevent cross-contamination between the chambers. Optional cover 64 is also provided, herein shown as a separate piece, but may be fixedly attached to the housing 62, e.g., with hinges, clamps, welds, etc.

Other vessel possibilities include, but are not limited to, cuvettes, culture dishes, cell culture flasks, roller bottles, culture tubes, culture vials, flexible bags, etc. Thus, any type of container may be used as a vessel of the subject systems.

In certain embodiments, a vessel may be configured for aseptic biological production of cells and/or microorganisms, e.g., a bioreactor. A vessel may be made of any suitable material, where such will be based at least in part on the particular application to which a given vessel is used. The subject invention is not limited to any particular vessel or vessel type. For example, vessels may be constructed of metals such as stainless steel (e.g., 316L type stainless steel), copper, aluminum; plastics; ceramics; and the like. The vessel may be a jacketed vessel (see for example jacket 69 of FIG. 8).

A vessel may be any suitable size, where the particular size depends on the particular applications, (e.g., experimental parameters, e.g., number of cell types, number of media, number of different conditions to test, etc). The skilled artisan can readily determine the appropriate vessel (e.g., cell cultivation vessel) to employ. depending on the particular applications with which it is used. A vessel may be relatively small, e.g., for small scale applications or relatively large, e.g., for large scale manufacturing applications such as for use in large scale continuous or batch manufacturing protocols, e.g., large scale continuous or batch cell culture manufacturing protocols. The sizes of the vessels may vary over several orders of magnitudes. The volumetric capacity of chamber 63 may, in certain embodiments, range from about 5×10⁻³ liters to about 5×10⁸ liters or more, e.g., from about 20 liters to about 5×10⁴ liters, e.g., from about 450 liters to about 550 liters. For example, an exemplary shake flask may range from about 100 to about 1000 ml in certain embodiments, an exemplary laboratory fermenter may range from about 1 to about 50 L in certain embodiments, an exemplary pilot scale cell culture bioreactor may range from about 20 liters to about 1000 liters in certain embodiments, and an exemplary batch or process scale cell culture bioreactor may range from about 50 liters to about 5000 liters in certain embodiments.

As noted above, system embodiments may also include a liquid. As the subject systems may be used in a wide variety of applications, the liquid of a system will vary depending on the particular application. The subject invention is not limited to any particular liquid. For example, for water treatment applications, the liquid may be wastewater, for food science applications the liquid may be a component in a food product. In certain embodiments, the liquid may be a cell culture medium or media, the particulars of which will vary depending on the particular application. For example, the culture medium employed will depend at least in part upon the particular cell type(s) being cultivated. Determining the appropriate culture medium or media is well-within the purview of the skilled artisan. For example, one of skill in the art can readily determine which media to employ based on the known basic nutrient requirements of the cell type(s). For example, for mammalian cell culture systems, growth medium may be employed in certain embodiments, such as RPMI, DME, Iscove's IMDM, and the like.

An exemplary medium for culturing the bacterium E-coli may include glucose, Na₂HPO_{4,} KH₂PO_{4,} NH₄Cl, NaCl, MgSO_{4,} CaCl_{2.} An exemplary medium for culturing the human cells may include all 20 of the amino acids; a purine and a pyrimidine for the synthesis of nucleotides, and their polymers DNA and RNA; precursors needed to synthesize some of the phospholipids; vitamins, the coenzyme lipoic acid; glucose, and inorganic ions such as Na⁺, K⁺, Ca²⁺, Cu²⁺, Zn²⁺, and CO²⁺. For example, such a nutrient broth may include: the 20 amino acids, biotin, calcium pantothenate, choline chloride, i-inositol, thiamine hydrochloride, hypoxanthine, folic acid, niacinamide, pyridoxine hydrochloride, riboflavin, thymidine, cyanocobalamin, sodium pyruvate, lipoic acid, CaCl_{2,} MgSO₄.7H₂O, glucose, NaCl, KCl, Na₂HPO_{4,} KH₂PO_{4,} phenol red, FeSO_{4,} CuSO₄.5H₂O, ZnSO₄.7H₂O and NaHCO_{3.} An exemplary medium for culturing the green algae may include NaNO₃, K₂HPO₄, KH₂PO₄, CaCl₂, NaCl, MgSO₄.7H₂O, FeCl₃, MnSO₄.4H₂O, ZnSO₄.7H₂O, H₃BO₃, CuSO₄.5H₂O. Numerous examples of cell culture medium are known to those of skill in the art and many are commercially available. Such cell culture medium may or may not contain serum.

Cell culture system embodiments also include cells. The subject invention is not limited to any particular cell or cell type. For example, the subject invention may include eukaryotic or prokaryotic cells, e.g., mammalian cells for producing recombinant proteins or vectors. The subject systems may include cells of one type or may include a mixture of cell types, e.g., mammalian cells infected with viral particles; in food science applications and wastewater treatment. The cells may be a homogenous population or may be a heterogeneous population. In certain embodiments, the cells may be of one type and are used to produce a vector or composition for cellular or gene therapy.

Systems may also include other componentry for carrying out the particular protocol at hand. Such componentry may include, but is not limited to, one or more of the following: a gas source which may include a regulator, gas (and liquid) lines for transporting gas from the gas source to the gas inlet opening of a subject sparger operatively associated with a vessel—which lines may include filters such as sterile filters installed on the gas lines to ensure that no contaminants are introduced into the vessels, pH and pO₂ probes, pumps, flow controllers, aseptic inoculation line, baffles, drain system, etc. The timing and the rates of recirculation and perfusion is dependent on the seeding cell density, and the cell growth which is monitored by amounts of nutrients e.g. glucose and metabolites, e.g. lactate, etc., over time. The gas source may be any suitable gas source, where the gas may be oxygen or an oxygen-containing gas (e.g., an oxygen/carbon dioxide mixture), or the like. A mixing element or liquid agitator may also be employed in the chamber to mix the liquid contents, e.g., a impeller-type mixer, stir bar, and the like.

Computer componentry may also be provided for carrying-out certain processes automatically. For example, a processor under the control of suitable programming may be included in the subject systems. A “computer”, “processor” or “processing unit” are used interchangeably and each references any hardware or hardware/software combination which can control components as required to execute recited steps. For example a computer, processor, or processor unit may include a general purpose digital microprocessor suitably programmed to perform all of the steps required of it, or any hardware or hardware/software combination which will perform those or equivalent steps. Programming may be accomplished, for example, from a computer readable medium carrying necessary program code (such as a portable storage medium) or by communication from a remote location (such as through a communication channel).

FIG. 8 shows a partial view of a system 100 that includes vessel 60 and an operatively associated sparger 10. The sparger may be permanently affixed to the vessel (e.g., may be provide to the user already affixed) or may be readily removable. A system with a fixed sparger may be less likely to be damaged or otherwise modified by excess handling than a sparger than a system with a readily removable sparger. As shown, sparger 10 is inserted into a fitting, e.g., a welded-in fitting, through a wall of the vessel. The vessel may be a jacketed vessel, as is known in the art. For example, as described above, sparger 10 may be inserted through an Ingold type fitting through the wall of jacketed vessel 60 at about a downward slope (e.g., at an angle β that may range from about −30° to about 30° relative to the wall of the vessel or relative to a line normal to a wall of the vessel, e.g., sparger 10 may be positioned at about a 15° downslope relative to a line normal to a wall of the vessel that it is associated with. In this particular embodiment, the sparger has sparge holes that do not encompass the entire circumference of the sparger and the sparger is positioned at a downward slope such that the sparge holes, and thus the sparged gas bubbles produced therefrom, are initially directed towards the bottom region of the vessel. However, it will be apparent that other configurations and orientations may be employed as well. For example, the sparger may be positioned to so that the sparge holes, and thus the sparged gas bubbles produced therefrom, are initially directed towards the top region of the vessel. A sparger also need not be limited to positioning at a side wall of a vessel as shown in FIG. 8 and may be, e.g., positioned on a bottom surface or even associated with a vessel cover.

METHODS

The subject invention also provides methods of introducing a gas to a liquid. Embodiments of the subject methods include positioning a sparger that includes a first member disposed within a second member having at least one sparge hole, inside a liquid present inside a vessel and directing gas into the second member from the first member to cause the gas to exit the at least one sparge hole of the second member.

Accordingly, in practicing the subject invention, a sparger as described above, is operatively positioned in a liquid retained within a vessel. The liquid may be any suitable liquid in need of gas introduction (or removal) such as in need of aeration or the like. The vessel may be any suitable vessel, e.g., may be a bioreactor or the like for performing cell culture protocols, with a requirement that the vessel in capable of retaining the liquid in a suitable manner and of withstanding any processing conditions to which it may be subjected.

A sparger may be positioned in any suitable orientation inside a liquid and in relation to the vessel with which it is used. The sparger and liquid are such that the liquid at least covers the one or more sparger holes of the sparger, and may cover the entire sparger in certain embodiments or at least the entire portion of the sparger positioned within the vessel.

A sparger may be placed on a bottom surface of the vessel, may be associated with a cover, etc. In certain embodiments, a sparger may be associated with a side wall of a vessel. In such instances, a sparger may be positioned at a downward slope (see for example FIG. 8) such that a sparger may be positioned at an angle β that may range from about −30° to about 30° relative to a line normal to a wall of the vessel, e.g., a sparger may be positioned at about a 15° downslope relative to a side wall of a vessel in certain embodiments.

If the sparger employed has sparge holes that do not encompass the entire circumference of the sparger, the sparger may be positioned in manner to cause the sparge holes, and thus the sparged gas bubbles produced therefrom, to be directed towards the lower or bottom region of the vessel. Such may be desired in certain applications in which it is desired to minimize liquid disturbance, e.g., certain cell culture protocols such as certain mammalian cell culture protocols. However, it will be apparent that other configurations and orientations may be employed as well. For example, the sparger may be positioned to so that the sparge holes, and thus the sparged gas bubbles produced therefrom, are directed towards the upper region of the vessel.

Once positioned, sparger gas may be introduced to the sparger and forced out of the one or more sparge holes of the sparger to the surrounding liquid in the form of bubbles, as shown by the arrows illustrating flow through sparger 10 of FIG. 2. During gas introduction, outlet 5, if present (see for example outlet 5 of FIG. 1), is usually partially or completely closed to flow, e.g., using a valve, plug, cap, or the like. Gas such as oxygen or oxygen-containing gas or other suitable gas or gas mixture is forced under pressure through the inner member of the sparger, and specifically is fed into the gas inlet opening of the inner member, and caused to flow into the outer member by way of the gas exit opening of the inner member. Since the outer member has at least one sparge hole and in many instance a plurality of sparge holes, e.g., along its lower surface, gas is released from the sparger through the one or more sparge holes to the surrounding liquid. In certain embodiments, the bubbling gas is passed to the liquid in a manner that minimizes disturbance of the liquid by the bubbles, as noted above. Embodiments include methods that provide bubbles having a mean diameter that falls within the ranges described above.

Gas may be introduced at any suitable flow rate. In certain embodiments, gas may be introduced at a flow rate that ranges from about 0 SLPM (standard liters per minute) to about 5×10⁶ SLPM, e.g., from about 0 SLPM to about 5×10⁴ SLPM , e.g., from about 1 SLPM to about 50 SLPM. Gas pressure may range from about 0 psi to about 5×10⁴ psi, e.g., from about 0 psi to about 1000 psi, e.g., from about 0 psi to about 30 psi.

Gas may be flowed through the sparger continuously or periodically, depending on the particular requirements of the liquid. Gas may be introduced to the sparger in a manner to maintain a certain gas level in the liquid. For example, the amount of gas in the liquid may be continuously or periodically monitored during a process. Gas introduction parameters may be modulated in response to the amount of gas determined to be present at a given time or over a given period of time. Such monitoring and modulation, if required, may be accomplished manually or automatically, e.g., with the use of suitable gas sensing elements and micro processors and electronic circuitry.

After gas sparging, and any processing of the liquid is complete, the sparger may be re-used or disposed. If re-used, the sparger may be cleaned and sterilized. As will be described in greater detail below, certain embodiments include leaving the sparger in place (i.e., operatively affixed to a vessel) and cleaning and/or sterilizing the sparger, i.e., while affixed to the vessel, with the rest of the vessel.

As described above, the subject methods may be employed in cell or microorganism culturing protocols. Such embodiments may include positioning a sparger, that includes a first member disposed within a second member having at least one sparge hole, inside a cell culture medium or microorganism culture medium present inside a cell or microorganism bioreactor and directing gas into the culture medium from the first member to cause the gas to exit the at least one sparge hole of the second member.

In such embodiments, an suitable amount of cell culture medium is introduced to the bioreactor that includes the sparger. In certain embodiments, the sparger may be permanently coupled to the bioreactor, e.g., the bioreactor wall, in a manner analogous to that described above. The amount of medium will vary depending on the particulars of the protocol, but will at least be sufficient to cover the one or more sparge holes of the sparger. The type of medium will vary depending on the type of cells or microorganisms to be cultured. The selection of a suitable medium is well within the knowledge of one of skill in the art.

The subject methods may be employed for small and large scale cell or microorganisms culturing, e.g., small and large scale mammalian cell culturing. In such large scale embodiments, a volume of cell or microorganism culture medium that ranges from about 700 to about 800 liters may be employed and may be retained in a bioreactor capable of holding such a volume for cell or microorganism culturing. Any suitable bioreactor may be used, where bioreactors are known and used for the production of biological products from both suspension and anchorage dependent animal cell cultures and may be adapted for use in the subject invention. It will be apparent that the embodiments of cell culturing are not limited to any particular bioreactor. Bioreactors used in embodiments of the subject invention may have the characteristic of high volume-specific culture surface area in order to achieve high producer cell density and high yield. In certain embodiments, a bioreactor may be a jacketed 316L type stainless steel pressure and vacuum rated bioreactor. In certain embodiments a bioreactor may be a stirred tank mammalian cell bioreactor. Instrumentation and controls may be the analogous to those employed in other fermentors and include agitation, temperature, dissolved oxygen, and pH controls. More advanced probes and autoanalyzers for on-line and off-line measurements of turbidity (a function of particles present), capacitance (a function of viable cells present), glucose/lactate, carbonate/bicarbonate and carbon dioxide may be employed.

Perfusion of fresh medium through the culture may be achieved by retaining the cells with a variety of devices, e.g. fiber disks, fine mesh spin filter, hollow fiber or flat plate membrane filters, settling tubes, etc. A simple perfusion process has an inflow of medium and an outflow of cells and products. Culture medium may be fed to the reactor at a predetermined and constant rate, which maintains the dilution rate of the culture at a value less than the maximum specific growth rate of the cells. Culture fluid containing cells and cell products and byproducts may be removed at the same rate.

In certain embodiments of the invention, suspension adapted cells may be used, which may be grown in serum-containing or serum-free medium. A perfused packed-bed reactor using a bed matrix of a non-woven fabric may be used for maintaining a perfusion culture at densities exceeding about 10⁸ cells/ml of the bed volume (CelliGen™, New Brunswick Scientific, Edison, N.J.) This system includes an improved reactor for culturing of both anchorage- and non-anchorage-dependent cells. The reactor is designed as a packed bed with means to provide internal recirculation. A fiber matrix carrier may be placed in a basket within the reactor vessel. A top and bottom portion of the basket has holes, allowing the medium to flow through the basket. A specially designed impeller provides recirculation of the medium through the space occupied by the fiber matrix for assuring a uniform supply of nutrient and the removal of wastes. This simultaneously assures that a negligible amount of the total cell mass is suspended in the medium. The fiber matrix is a non-woven fabric having a “pore” diameter of from 10 μm to 100 μm, providing for a high internal volume with pore volumes corresponding to 1 to 20 times the volumes of individual cells.

In introducing gas to the culture medium in the bioreactor, sparger gas may be introduced to the sparger and forced out of the one or more sparge holes of the sparger to the surrounding medium in the form of bubbles. During gas introduction, the outlet 5, if present (see for example outlet 5 of FIG. 1), is usually partially or completely closed to flow, e.g., using a valve, plug, cap, or the like. Gas such as oxygen or oxygen-containing gas or another gas or gas mixture is forced under pressure through the inner member of the sparger, and specifically is fed into the gas inlet opening of the inner member, and caused to flow into the outer member by way of the gas exit opening of the inner member. Since the outer member has at least one sparge hole and in many instance a plurality of sparge holes, e.g., along its lower surface, gas is released from the sparger through the one or more sparge holes to the surrounding medium. In certain embodiments, the bubbling gas is passed to the culture medium in a manner that minimizes disturbance of the culture medium, and more particularly the cells or microorganisms present, by the bubbles. Embodiments include methods that provide bubbles having a mean diameter that falls within the ranges described above.

Gas may be introduced at any suitable flow rate. In certain embodiments, gas may be introduced at a flow rate that ranges from about 0 SLPM to about 5×10⁶ SLPM , e.g., from about 0 SLPM to about 5×10⁴ SLPM, e.g., from about 1 SLPM to about 50 SLPM. Gas pressure may range from about 0 psi to about 5×10⁴ psi, e.g., from about 0 psi to about 1000 psi, e.g., from about 0 psi to about 30 psi.

Gas may be flowed through the sparger continuously or periodically, depending on the particular requirements of the cell culture protocol. Gas may be introduced to the sparger in a manner to maintain a certain gas level in the medium. For example, the amount of gas in the medium may be continuously or periodically monitored during a process. Gas introduction parameters may be modulated in response to the amount of gas determined to be present at a given time or over a given period of time. Such monitoring and modulation, if required, may be accomplished manually or automatically, e.g., with the use of suitable gas sensing elements and micro processors and electronic circuitry.

Once the fermentation process is complete, the cells or microorganisms may be harvested by removing the fermentation broth containing the cells or microorganisms and the extracellular media from the bioreactor. Once removed the bioreactor may be re-used in certain embodiments. The sparger may be re-used or disposed following the completion of the cell or microorganism culturing process. If re-used, the sparger may be cleaned and sterilized, e.g., in place (i.e., operatively affixed to the biorector) such that the sparger and bioreactor may be cleaned and/or sterilized together.

METHODS FOR PROCESSING A SPARGER

The subject invention also provides methods for processing a sparger such as cleaning or sterilizing a sparger. Embodiments of the subject processing methods include clean-in-place (CIP) processes such that a sparger may be cleaned on-line or rather while coupled to a vessel. Embodiments of the subject processing methods include sterilize-in-place (SIP) processes such that a sparger may be sterilized on-line or rather while coupled to a vessel. An important feature of embodiments of the subject methods is that the spargers may be cleaned and/or sterilized in place according to FDA standards. After each use of a subject sparger, the sparger may be re-used without having to be removed from the vessel with which it is used for cleaning and sterilization between uses and may be left in place, coupled to the vessel, and cleaned and sterilized in place with the rest of the vessel using the subject CIP and SIP methods.

As noted above, the ability to CIP and SIP a sparger provides a number of advantages, such as reduced labor, reduced vessel/sparger downtime, and reduced risk of sparger damage from handling. Furthermore, the subject CIP and SIP methods may be employed in highly automated formats using computer controlled automated CIP and SIP systems, thereby further reducing human handling.

As noted above, in certain instances, the subject gas spargers may be used in cell culture applications such as mammalian cell culture applications. In certain of these applications, it is important that cell turbulence is minimized to protect the cells. However, conventional spargers are not configured to both supply gas bubbles of sizes small enough to minimize cell turbulence to a suitable level and be able to be cleaned in place and/or sterilized in place, and particularly CIP and/or SIP according to FDA standards, thus requiring the conventional spargers to be removed from the vessel with which they are used so that they can be cleaned or sterilized—or simply removed and discarded.

In general, the subject methods include directing a cleaning solution or clean steam into an outer member of a subject sparger from the sparger's inner member. The novel configuration of the subject spargers enables the spargers to be cleaned and sterilized according to FDA regulations and particularly are able to provide FDA compliant flow rates for cleaning and sterilization.

As noted above, embodiments include cleaning and sterilizing a subject sparger, where in many embodiments a sparger may be cleaned in place and sterilized in place. The subject sparger cleaning and sterilizing methods are further described primarily with respect to CIP and SIP methods for exemplary purposes only and are in no way intended to limit the scope of the invention. It will be apparent that the sparging cleaning and sterilizing methods may be adapted to cleaning and sterilizing a sparger that has been removed from a vessel.

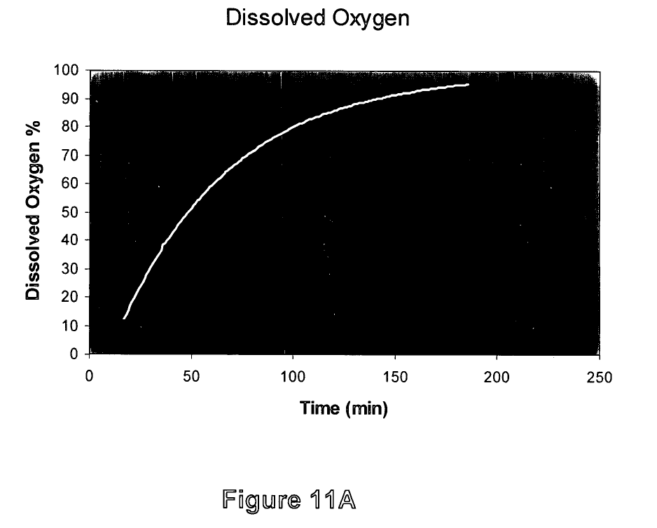

In cleaning a sparger that is operatively coupled to a vessel (e.g., in a manner described above), the outlet 5, if present, is opened. A cleaning solution at a velocity that ranges from about 3 feet/second to about 10 feet/second is introduced into the inlet opening 4 of the inner member 2 using a hose connection from a cleaning solution source. In other words, in certain embodiments a sparger is dimensioned to provide a liquid velocity within the sparger that ranges from about 3 ft/sec to about 10 ft/sec, e.g., at a pressure of about that ranges from about 0 psi to about 125 psi. The cleaning solution flows through the inlet opening 4 of the inner member and flows back through the outer member 1 and exits the sparger from outlet 5, with some of the cleaning solution exiting through one or more sparge holes 7, as shown by the arrows illustrating cleaning solution (or rinse liquid) flow through sparger 10 of FIG. 9. This process may be followed by the introduction of a rinse fluid in an analogous manner.

While not wishing to be tied to any particular theory, cleaning according to the subject methods may be accomplished by a combination of mechanisms such as primarily chemical by the cleaning solution chemistry and secondarily mechanical by the turbulence provided in the sparger. Achieving a linear velocity through the inner member and outer members that ranges from about 3 feet/second to 10 feet/second enables suitable turbulence flow to be obtained which meets federal current good manufacturing practices (cGMP) for cleaning such devices such as spargers, e.g., cGMP of product contact surfaces in the production of biological therapeutics. Accordingly, embodiments of the subject spargers are so configured to provide this linear velocity.

In many embodiments, cleaning a sparger in place in a vessel is accomplished automatically with the use of an automatic pumping mechanism that supplies the cleaning and rinsing liquids to the sparger, and in many instances to the vessel at the simultaneously.

The amount of cleaning solution employed will vary depending on the dimensions of the sparger being cleaned. For examples, cleaning a sparger having a length dimension that ranges from about 30 cm to about 65 cm and outer diameter dimensions that range from about 1.5 cm to about 2.5 cm, and a number of sparge holes ranging from about 10 to about 100 and having a mean diameter that ranges from about 400 μm to about 600 μm, may include introducing a volume of cleaning solution into the sparger that may range from about 0.5 liter to about 1.5 liters. The volume of rinse liquid may range from about 0.5 liters to about 1.5 liters.

Any suitable cleaning solution and rinse solution may be employed. Cleaning solutions may be caustic and acidic solutions. Exemplary cleaning solutions include, but re not limited to, H₃PO₄, NaOH, KOH, H₂O, Citric Acid, and the like. Rinse solutions may be water, e.g., sterile water or deionized water. In certain embodiments, the cleaning solution and rinsing solutions are heated solutions, e.g., to a temperature that ranges from about 0° C. to about 100° C.

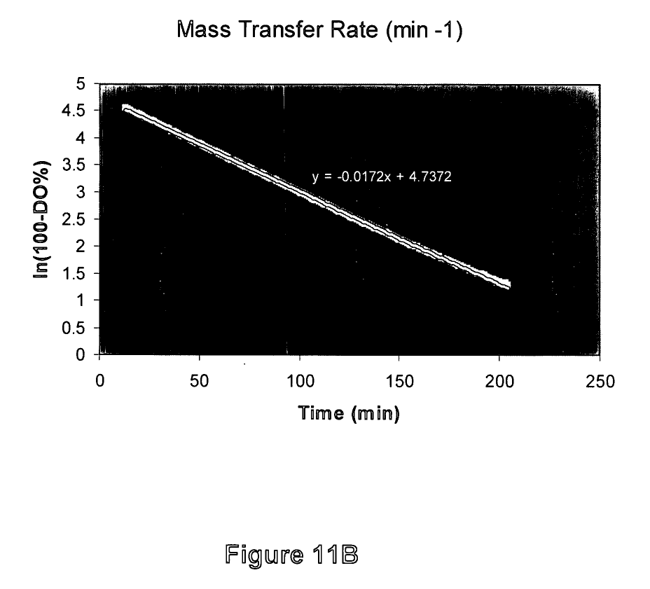

In sterilizing a sparger that is operatively coupled to a vessel (e.g., coupled to a vessel in a manner described above), outlet 5 is operatively connected to a sanitary type steam trap and the outlet is opened during the sterilization process (e.g., a valve associated with the outlet is opened). A USP clean steam source is introduced into the inlet opening 4 of the sparger at a pressure that ranges from about 0 psi to about 1000 psi, e.g., from about 0 psi to about 125 psi, e.g., from about 20 psi to about 30 psi and steam flows through the inner member to the outer member in a manner analogous to that described above such that steam exits the sparger through the sparger holes and also flows out outlet 5 into the steam trap, as shown by the arrows illustrating steam flow and steam condensate flow through sparger 10 of FIG. 10. In this manner, the sparger may be steamed in place with the vessel, with steam flowing into the vessel through the one or more sparge holes which may assist in sterilizing the vessel as well. After SIP, the steam source and trap are removed and the vessel/sparger may be used. In certain embodiments, the temperature of the steam may range from about 120° C. to about 130° C.

To remove condensate from the sparger, gravity draining may be employed whereby condensate is removed from the sparger via one or more sparge holes. More specifically, a sparger may be positioned in a manner to facilitate gravity draining of condensate during SIP processes. As described above, in certain embodiments the sparger may be oriented at an angle that ranges from about −30° to about 30°, e.g., about 15°, relative to a vessel wall or relative to a line normal to a wall of the vessel, and at least one sparge hole may be positioned about the distal end of the sparger in a manner to be at a low point, e.g., the lowest point, of the sparger when so positioned in a vessel. In this manner, steam condensate may gravity drain from the sparger during SIP by draining from the one or more low point sparge holes.

During sterilization, all process contact surfaces are exposed to steam of a temperature of about 121.1° C. or greater saturated steam for the sterilization exposure time, which time may vary depending on the dimensions of the sparger and vessel, but may range from about 5 minutes to about 500 minutes.

UTILITY

The subject invention finds use in a variety of applications in which it is desired to introduce a gas into a liquid. Applications include biotechnology, pharmaceutical development, wastewater treatment, food science, and the like.

The subject invention may find use in cell or microorganism applications. For example, plant cells have been cultured to produce ingredients needed by the food industries, such as flavor agents, colorants, essential oils, sweeteners, antioxidants, and the like.

There are a number of applications in which animal cell cultures may find use, including, but not limited to, production of viral vectors for therapeutic applications, investigation of the physiology or biochemistry of cells (e.g., in the study of cell metabolism), investigation of the effects of various chemical compounds or drugs on specific cell types (normal or cancerous cells for example), investigation into the sequential or parallel combination of various cell types to generate artificial tissue (e.g., tissue engineering applications). In certain embodiments, biologicals may be synthesized from large scale cell cultures.

For example, biologicals so synthesized encompass a broad range of cell products and includes, but is not limited to, specific proteins or viruses (e.g., for viral vaccines or the like) that require animal cells for propagation. For example, viral vectors and therapeutic proteins may be synthesized in large quantities by growing cells genetically engineered to produce such viral vectors or to express recombinant protein in large-scale cultures.

KITS

Finally, novel kits are also provided. Kit embodiments at least include at least one sparger according to the subject invention and in certain embodiments a plurality of such spargers. Certain kit embodiments may also include a vessel for retaining a liquid in need of sparging, e.g., a bioreactor or the like. In embodiments that include both a vessel and a subject sparger, the sparger may be provided coupled to the vessel or may be provided as a separate kit component, e.g., provided in a kit but not yet coupled to a vessel.

In certain embodiments, a sparger may be provided for retrofitting a vessel so it may use a subject sparger. Retrofitting kits may be provided that include one or more spargers and tools and instructions for retrofitting a vessel, e.g., fittings and the like.

The kits may further include one or more additional components necessary for carrying out a protocol such as a cell culture protocol, such as cell culture medium or one or more components used in the preparation of a cell culture medium, buffers, and the like.

The subject kits may also include written instructions for operatively coupling sparger to a vessel and/or for using the subject spargers to introduce (or remove) gas into a liquid and/or for cleaning and/or sterilizing a subject sparger, e.g., with or without removing it from a vessel with which it is used for gas introduction. Instructions of a kit may be printed on a substrate, such as paper or plastic, etc. As such, the instructions may be present in the kits as a package insert, in the labeling of the container of the kit or components thereof (i.e., associated with the packaging or sub-packaging) etc. In other embodiments, the instructions are present as an electronic storage data file present on a suitable computer readable storage medium, e.g., CD-ROM, diskette, etc. In yet other embodiments, the actual instructions are not present in the kit, but means for obtaining the instructions from a remote source, e.g. via the Internet, are provided. An example of this embodiment is a kit that includes a web address where the instructions can be viewed and/or from which the instructions can be downloaded. As with the instructions, this means for obtaining the instructions is recorded on a suitable substrate.

In certain embodiments of the subject kits, the components of a subject kit may be packaged in a kit containment element to make a single, easily handled unit, where the kit containment element, e.g., box or analogous structure, may or may not be an airtight container, e.g., to further preserve the integrity (e.g., sterility) of one or more components until use.

### EXPERIMENTAL

The following experiment is put forth so as to provide those of ordinary skill in the art with a complete disclosure and description of how to make and use the present invention, and are not intended to limit the scope of what the inventors regard as their invention. Efforts have been made to ensure accuracy with respect to numbers used (e.g. amounts, temperature, etc.) but some experimental errors and deviations should be accounted for. Unless indicated otherwise, parts are parts by weight, molecular weight is weight average molecular weight, temperature is in degrees Centigrade, and pressure is at or near atmospheric.

500-L Bioreactor Sparger Operation

Bioreactor Configuration

An engineered 500 Liter working volume cell culture perfusion bioreactor with a total internal volume of approximately 750 liters and internal diameter of 24″ was used to grow human mammalian cells in suspension. Inside the bioreactor was an agitator with impellers that are used in combination with tank sidewall baffles to maintain the suspended cells in a homogeneous solution, to affect heat exchange at the tank wall, and to aid in the efficient exchange of liquids and gases in solution. The tank had an external dimple jacket containing a glycol solution supplied by a heat exchanger and re-circulation pump, to control and maintain temperature of the bioreactor contents at 37° C. Headspace pressure of the bioreactor was maintained at about 5 psi in order to provide a greater level of assurance that sterility would not be compromised if a leak occurs.

Use of the Sparger

Compressed air, carbon dioxide, and oxygen were supplied to the sparger from a remote gas rack containing an electronic mass flow controller for each gas. All three gas lines coalesce into a common line and were mixed before reaching the sparger. The cell culture operator is capable of adjusting the gas flow rate for each individual gas using a touch screen HMI interface located in the Cell Culture suite. During automated operations, the gas flow rates and mixing ratios are determined by the control system and are controlled automatically from a pre-defined recipe.

Oxygen Mass Transfer Experiment

The following example demonstrates the ability of an exemplary sparger of the present invention to transfer dissolved oxygen into a liquid cell culture medium. In an oxygen mass transfer experiment, a total volume of 452 liters of sterile Dulbecco's Phosphate buffered Saline (DPBS) medium was introduced into the 500-liter perfusion bioreactor. Compressed oxygen was sterilized through a 0.2 micron filter and continuously dispensed into the medium at a flow rate of 3.6 SLPM through the sparger, which was positioned in the medium near the bottom of the tank and angled toward the bottom of the tank at 15 degrees. The percentage of dissolved oxygen in the medium was monitored over a period of about 200 minutes by the dissolved oxygen sensor.

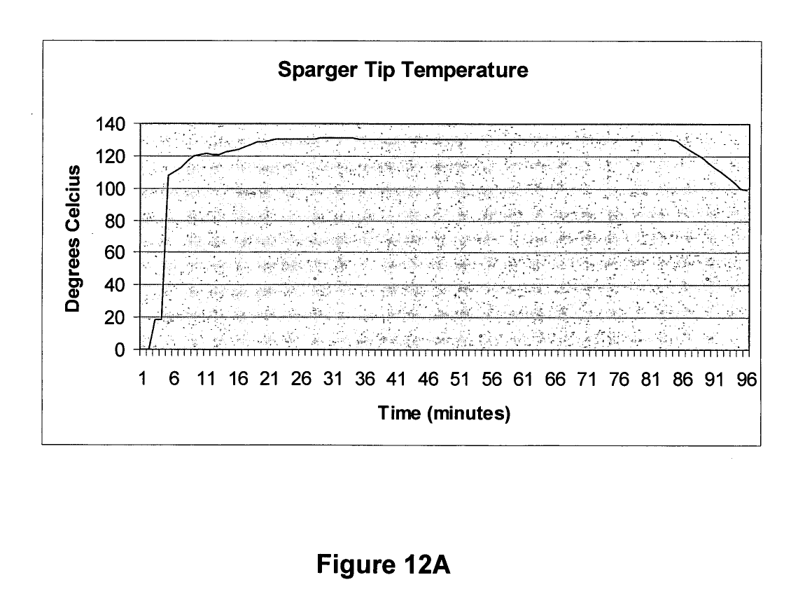

As shown in Table 1, after an initial lag period, the percent of dissolved oxygen increased proportionally over the remaining time course of the experiment (shown graphically in FIG. 11A), eventually reaching saturating conditions at about 200 minutes. From these empirical data, the mass transfer rate was calculated by plotting the natural log of [(100−DO %)] over time (FIG. 11B) yielding a mass transfer rate of y=−0.0172x+4.7372 min−1. The dissolved oxygen exchange rate shown in FIG. 11A is highly desirable for large-scale culture of mammalian cells, particularly human cancer vaccine cells. Furthermore, the sparger dispenses oxygen through numerous tiny holes, rather than a single large outlet, thereby reducing mechanical and shear stress making the bioreactor ideal for culturing mammalian cells that are sensitive to shear stress forces.

The cell process required a combination of constant air sparge and an exponential decrease of CO₂ for approximately three days, followed by constant air sparge and oxygen supplementation on demand based on feedback from the dissolved oxygen sensor. As the cell concentration increases, the oxygen demand and therefore oxygen flow rate increases.

Cleaning of the Sparger

The bioreactor was cleaned in place (CIP) using a remotely operated CIP skid located in another room. Cleaning and rinsing solutions were supplied from the CIP skid to the bioreactor using a 1.5″ diameter stainless steel pipe located adjacent to the bioreactor. Several hoses connect the CIP supply pipe to multiple tank peripherals for cleaning of individual tank parts. Connection points are to the spray ball for cleaning the tank internal surfaces, the inoculation port where cells are introduced to the bioreactor, the sample valve assembly, the media feed pipe, and the sparger.

Sterilization of the Sparger

The sparger was steamed in place during steam sterilization of the bioreactor. Clean steam was supplied to the sparger from a header located near the top of the bioreactor. Steam entered the sparger inlet and its condensate removed at the outlet using a steam trap. Some steam flows through the sparge holes and into the bioreactor.

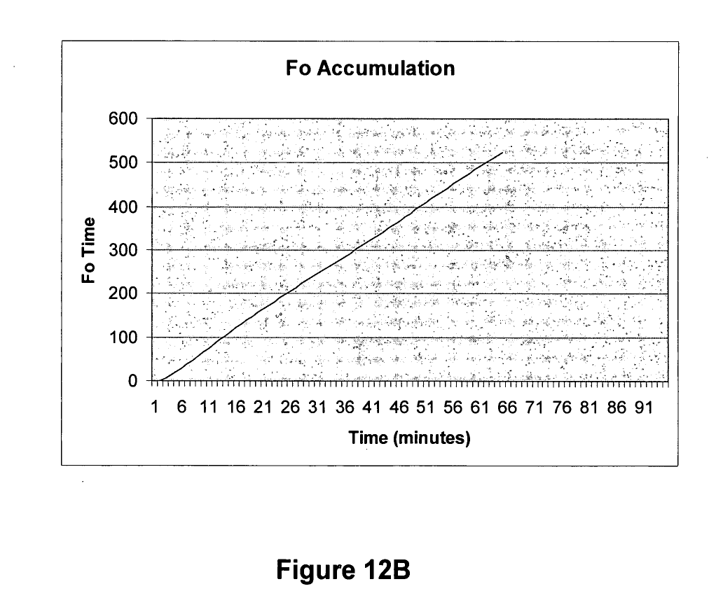

The ability of an exemplary sparger of the present invention to be steam sterilized-in-place in a 500 liter bioreactor is shown in FIGS. 12A and B. Clean steam was supplied to the sparger from the header of a 500-liter bioreactor (Bioreactor V-0302) and temperature data were collected using a thermocouple inserted into the sparger and connected to a Kaye Digistrip unit. As steam enters the sparger inlet, the sparger tip temperature rapidly increases and reached temperatures suitable for sterilization (e.g., above 121° C.) within minutes and can be maintained for a period of almost 90 minutes (FIG. 12A). The number of equivalent minutes of steam sterilization at temperature 121.1° C. delivered to the bioreactor (Fo Time) was calculated using the formula: Fo=§ 10ˆ((T−121)/z)*dt, wherein T is temperature, z is the z-value of 10° C. The Fo accumulation over time is graphically shown in FIG. 12B. An optimal Fo Time for sterilizing bioreactors for large-scale culture of mammalian cells is about 30 minutes. The equation used to determine Fo is the following.

$${\int }_{0}^{t} {10}^{\frac{( T - 121.1 )}{z}} ⅆ t$$

Where

t is the exposure (or SIP) time and

T is the SIP temperature and

Z is a constant with temperature units.

It is evident from the above results and discussion that the above described invention provides devices and methods for introducing (and/or removing) a gas into (and/or from) a liquid. Embodiments of the subject invention provide for a number of advantages and features including, but not limited to one or more of, ease of use, versatility with a variety of different vessels, versatility with a variety of different applications, and the ability to clean and/or sterilize a subject device in-place. As such, the subject invention represents a significant contribution to the art.

All publications and patents cited in this specification are herein incorporated by reference as if each individual publication or patent were specifically and individually indicated to be incorporated by reference. The citation of any publication is for its disclosure prior to the filing date and should not be construed as an admission that the present invention is not entitled to antedate such publication by virtue of prior invention.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the present invention. All such modifications are intended to be within the scope of the claims appended hereto.

What is claimed is:

1. A sparger comprising:
an inner member having a gas inlet opening and at least one gas outlet opening; and
an outer member comprising at least one sparge hole.

2. The sparger of claim 1, wherein said at least one sparge hole has a diameter that ranges from about 200 μm to about 5 cm.

3. The sparger of claim 1, wherein said sparger has from about 1 to about 10,000 sparge holes.

4. The sparger of claim 1, wherein said inner member has a length that ranges from about 5 cm to about 50 meters.

5. The sparger of claim 1, wherein said inner member has inner diameter that ranges from about 1 mm to about 15 cm.

6. The sparger of claim 5, wherein said inner diameter of said inner member is constant.

7. The sparger of claim 1, wherein said inner member has outer diameter that ranges from about 1 mm to about 15 cm.

8. The sparger of claim 1, wherein said outer member has a length that ranges from about 5 cm to about 50 meters.

9. The sparger of claim 1, wherein said outer member has inner diameter that ranges from about 5 mm to about 15 cm.

10. The sparger of claim 9, wherein said inner diameter of said outer member is constant.

11. The sparger of claim 1, wherein said outer member has outer diameter that ranges from about 5 mm to about 15 cm.

12. The sparger of claim 1, wherein said outer member comprises an open end and a closed end, and said gas outlet opening of said inner tube is spaced a distance from said closed end of said outer member that ranges from about 1 cm to about 100 cm.

13. The sparger of claim 1, wherein said sparger is dimensioned to provide a gas flow rate within said sparger that ranges from about 0 SLPM to about 5×10⁶ SLPM at a pressure of about that ranges from about 0 psi to about 5×10⁴ psi.

14. The sparger of claim 1, wherein said sparger is dimensioned to provide a liquid velocity within said sparger that ranges from about 3 feet/second to about 10 feet/second at a pressure of about that ranges from about 1 psi to about 125 psi.

15. A vessel comprising the sparger of claim 1.

16. The vessel of claim 15, wherein the vessel is a cell or microorganism culture bioreactor.

17. The vessel of claim 15, wherein said sparger is coupled to a wall of said vessel.

18. A system comprising:
a vessel for containing a liquid; and
a sparger comprising:
i. an inner member having a gas inlet opening and at least one gas outlet opening, and
ii. an outer member comprising at least one sparge hole.

19. The system of claim 18, wherein said vessel is a cell culture bioreactor.

20. The system of claim 18, further comprising a liquid in said vessel.

21. The system of claim 20, wherein said liquid is cell culture medium.

22. The system of claim 21, wherein said cell culture medium further includes cells.

23. The system of claim 22, wherein said cells are mammalian cells.

24. The system of claim 18, further comprising at least one gas source.

25. The system of claim 18, wherein said sparger is positioned at an angle that ranges from about −30° to about 30° relative to a line normal to a wall of the vessel.

26. A method for introducing a gas into a liquid, said method comprising:
positioning a sparger inside liquid-filled vessel, wherein said sparger comprises a first member disposed within a second member having at least one sparge hole, and
directing a gas into said second member from said first member to cause said gas to exit said at least one sparge hole of said second member, whereby said exited gas is introduced into said liquid.

27. The method of claim 26, wherein said introduced gas is in the form of bubbles.

28. The method of claim 27, wherein said bubbles have a mean diameter that ranges from about 100 μm to about 1 meter.

29. The method of claim 28, wherein said bubbles have a mean diameter that ranges from about 0.5 mm to about 5 cm.

30. The method of claim 26, wherein said gas is introduced at a flow rate that ranges from about 0 SLPM to about 5×10⁶ SLPM.

31. The method of claim 30, wherein said gas is introduced at a flow rate that ranges from about 0 SLPM to about 1,000 SLPM.

32. The method of claim 26, wherein said gas is oxygen or an oxygen-containing gas.

33. The method of claim 26, further comprising cleaning said sparger without removing said sparger from said vessel.

34. The method of claim 33, wherein said cleaning comprises introducing a cleaning solution to said sparger at a flow rate that ranges from about 3 feet/second to about 10 feet/second.

35. The method of claim 26, further comprising sterilizing said sparger without removing said sparger from said vessel.

36. The method of claim 35, wherein said sterilization comprises introducing steam into said sparger at pressure that ranges from about 0 psi to about 1000 psi.

37. The method of claim 36, wherein said sterilization comprises introducing steam into said sparger at pressure that ranges from about 0 psi to about 125 psi.

38. The method of claim 37, wherein further comprising condensing at least some of said steam inside said sparger and draining said condensed steam from said sparger through said at least one sparge hole of said sparger.

39. A method for culturing cells or microorganisms, said method comprising:
positioning a sparger inside a cell or microorganism culture medium present inside a bioreactor, wherein said sparger comprises a first member disposed within a second member having at least one sparge hole, and directing a gas into said second member from said first member to cause said gas to exit said at least one sparge hole of said second member, whereby said exited gas is introduced into said cell or microorganism culture medium.

40. The method of claim 39, wherein said cell culture medium is mammalian cell culture medium.

41. The method of claim 39, wherein said mammalian cell culture medium comprises mammalian cells.

42. The method of claim 39, further comprising cleaning said sparger without removing said sparger from said bioreactor.

43. The method of claim 42, wherein said cleaning comprises introducing a cleaning solution to said sparger at a flow rate that ranges from about 3 feet/second to about 10 feet/second.

44. The method of claim 39, further comprising sterilizing said sparger without removing said sparger from said cell culture bioreactor vessel.

45. The method of claim 44, wherein said sterilization comprises introducing steam into said sparger at pressure that ranges from about 0 psi to about 1000 psi.

46. The method of claim 45, wherein said sterilization comprises introducing steam into said sparger at pressure that ranges from about 0 psi to about 125 psi.

47. A method of cleaning a sparger comprising an inner member having a gas inlet opening and at least one gas outlet opening, and an outer member comprising at least one sparge hole, said method comprising:
directing a cleaning solution into said second member from said first member to cause said cleaning solution to exit said at least one sparge hole of said second member.

48. The method of claim 47, wherein the flow rate of said cleaning solution in said sparger ranges from about 3 feet/second to about 10 feet/second.

49. The method of claim 47, further comprising directing a rinse liquid into said second member from said first member to cause said cleaning solution to exit said at least one sparge hole of said second member.

50. The method of claim 47, wherein said sparger is affixed to a vessel.

51. A method of sterilizing a sparger comprising an inner member having a gas inlet opening and at least one gas outlet opening, and an outer member comprising at least one sparge hole, said method comprising:
directing steam into said second member from said first member to cause said steam to exit said at least one sparge hole of said second member.

52. The method of claim 51, wherein said steam is at a temperature that ranges from about 120° C. to about 130° C.

53. The method of claim 48, wherein said steam is introduced to said sparger at pressure that ranges from about 0 psi to about 1000 psi.

54. The method of claim 53, wherein said sterilization is introduced to said sparger at pressure that ranges from about 0 psi to about 125 psi.

55. The method of claim 51, wherein said sparger is affixed to a vessel.

56. A kit comprising:
a sparger for introducing a gas into a liquid, said sparger comprising:
an inner member having a gas inlet opening and at least one gas outlet opening, and
an outer member comprising at least one sparge hole; and
a vessel for use with said sparger.

57. A kit comprising:
a sparger for introducing a gas into a liquid comprising:
an inner member having a gas inlet opening and at least one gas outlet opening, and
an outer member comprising at least one sparge hole; and
instructions for processing said sparger while coupled to a vessel.

58. The kit of claim 57, wherein said processing is at least one of cleaning or sterilizing.
